(19) United States
(12) Patent Application Publication
(10) Pub. No.: US 2007/0252431 A1
(43) Pub. Date: Nov. 1, 2007

(54) Brake fluid pressure controlling unit for vehicle

(76) Inventors: Takao Tsunooka, Kariya-city (JP); Yoshitami Saito, Kariya-city (JP)

Correspondence Address: BUCHANAN, INGERSOLL & ROONEY PC, POST OFFICE BOX 1404, ALEXANDRIA, VA, 22313-1404, US

(21) Appl. No.: 11/785,854

(22) Filed: Apr. 20, 2007

(30) Foreign Application Priority Data
Apr. 26, 2006 (JP) 2006-121878

(51) Int. Cl. B60T 8/36

(52) U.S. Cl. 303/119.3

(57) ABSTRACT

A brake fluid pressure controlling unit for a vehicle includes a metal fluid pressure controlling block, a cover, a circuit board, an electronic component, and an electric conductor. The metal fluid pressure controlling block is electrically connected with a body of the vehicle. The cover is fixed to the fluid pressure controlling block. The circuit board is received inside the cover, wherein an electronic control unit is mounted on the circuit board. The electronic component is assembled to the fluid pressure controlling block. The electric conductor is connected with a grounded portion of the circuit board in the cover, the grounded portion being grounded, wherein the electric conductor electrically connects the fluid pressure controlling block with the grounded portion of the circuit board.

### CROSS REFERENCE TO RELATED APPLICATION

This application is based on and incorporates herein by reference Japanese Patent Application No. 2006-121878 filed on Apr. 26, 2006.

### BACKGROUND OF THE INVENTION

1. Field of the Invention

The present invention relates to a brake fluid pressure controlling unit employed for a hydraulic brake system for a vehicle, the system having a function, such as electronic stability control (ESC), which is also named as vehicle stability control (VSC).

2. Description of Related Art

For example, JP No. 3710061 has been disclosed as a brake fluid pressure controlling unit for a vehicle. Also, JP-A-H11-258089 discloses a semiconductor pressure sensor, which can sense a pressure inside a circuit of a brake fluid pressure controlling system.

The brake fluid pressure controlling unit disclosed in JP No. 3710061 includes a metal fluid pressure controlling block (housing), which has a fluid pressure circuit and multiple fluid pressure controlling valves, and an electronic control block. The electronic control block includes a case, which is fixed to the fluid pressure controlling block, a cover, which is externally provided to the case, and a circuit board, on which an electronic control unit is mounted. The case covers the fluid pressure controlling valves mounted on the fluid pressure controlling block, and the circuit board is received in a chamber formed between the case and the cover. A pressure sensor is fixed on the fluid pressure controlling block for sensing the fluid pressure in the fluid pressure circuit.

As for a pressure sensor disclosed by JP-A-H11-258089, a protection measurement from an electrical noise is made inside an electronic component included by the sensor, and specifically, a polysilicon cap is provided to serve as a shield electrode such that a fixed electrode and a movable electrode inside are protected from a noise.

For example, as above, in a case, where the fluid pressure in the circuit is to be sensed by a pressure sensor inside the fluid pressure controlling block of the brake fluid pressure controlling unit, a sensor with an electrical noise protection, which is similar to that disclosed in JP-A-H11-258089, is employed as the pressure sensor.

In general, a fluid pressure controlling block is electrically connected with a vehicle body through a brake hose and the like. Also, a potential difference is generated between the fluid pressure controlling block and a grounded portion (ECU GND) of the circuit board, which is connected with a battery of the vehicle through a harness and the like, due to an influence of a difference of the external wires in length.

The potential difference induces noises applied to the electronic component mounted on the fluid pressure controlling block, and as a result, the electronic component may abnormally operate to cause an adverse effect on fluid pressure control. For example, when the electronic component serves as a sensor that senses information for the fluid pressure control (the pressure sensor is one example of the sensor), the electronic control unit mounted on the circuit board may receive abnormal information from the sensor, therefore degrading reliability of the control. Therefore, in a case, where the electronic component, such as a semiconductor pressure sensor, is provided inside the fluid pressure controlling block, an electrical noise protection measure for the electronic component is required to avoid the above disadvantages.

The electrical noise protection measure is provided normally inside the electronic component. This is also true for the pressure sensor disclosed in JP-A-H11-258089. However, in a case, where the above measure is provided inside the electronic component, the electronic component itself may have to be replaced by another, which is more noise resistant, when used in a more severe noise environment. Thus, if another component with a high noise resistance is required, this may bring disadvantages in productivity, a parts control, and cost.

Different vehicle models have different sensitivities to radio noises. Thus, a certain electronic component, which does not brings any disadvantages when used in a certain vehicle model, may abnormally operate due to the induced noise when the electronic component is mounted on a different vehicle model. Also, even when used in the same vehicle models, one electronic component at one location may be more likely to be influenced by the induced noises than another electronic component at another location depending on the locations of the electronic components in the vehicle body. In a case, where the above potential difference is large, the noise is more likely to be induced. Further, it is desirable to reduce the possibility of the abnormal operation of the electronic component to zero as close as possible in a sever environment, such as a region directly below the antenna, which is subjected to a sever radio wave.

### SUMMARY OF THE INVENTION

The present invention is made in view of the above disadvantages. Thus, it is an objective of the present invention to address at least one of the above disadvantages.

To achieve the objective of the present invention, there is provided a brake fluid pressure controlling unit for a vehicle, which includes a metal fluid pressure controlling block, a cover, a circuit board, an electronic component, and an electric conductor. The metal fluid pressure controlling block is electrically connected with a body of the vehicle. The cover is fixed to the fluid pressure controlling block. The circuit board is received inside the cover, wherein an electronic control unit is mounted on the circuit board. The electronic component is assembled to the fluid pressure controlling block. The electric conductor is connected with a grounded portion of the circuit board in the cover, the grounded portion being grounded, wherein the electric conductor electrically connects the fluid pressure controlling block with the grounded portion of the circuit board.

### BRIEF DESCRIPTION OF THE DRAWINGS

The invention, together with additional objectives, features and advantages thereof, will be best understood from the following description, the appended claims and the accompanying drawings in which:

FIG. 1 is a cross-sectional view of a brake fluid pressure controlling unit according to one embodiment of the present invention;

FIG. 2 is a cross-sectional view of a brake fluid pressure controlling unit according to another embodiment of the present invention;

FIG. 3 is cross-sectional view of a brake fluid pressure controlling unit according to another embodiment of the present invention; and

FIG. 4 is a circuit diagram of a brake fluid pressure controlling system for a vehicle, which employs a brake fluid pressure controlling unit according to another embodiment of the present invention.

### DETAILED DESCRIPTION OF PREFERRED EMBODIMENTS

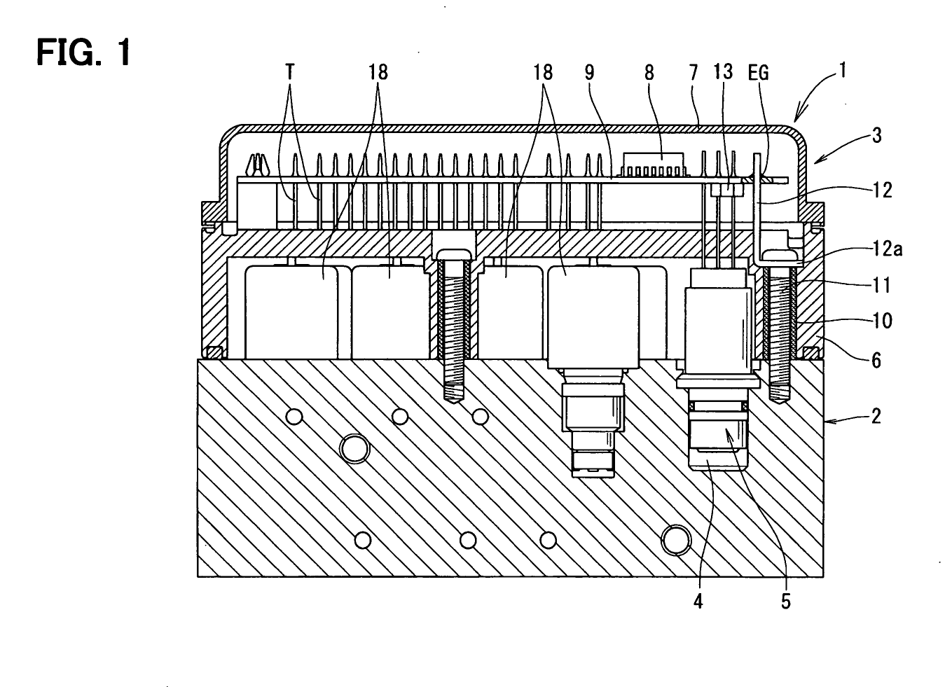

An embodiment of the present invention will be described below with reference to the accompanying drawing of FIGS. 1 to 4. FIG. 1 shows one embodiment of the present invention. A brake fluid pressure controlling unit 1 for a vehicle of the present embodiment includes a metal fluid pressure controlling block 2 and a controller 3.

The fluid pressure controlling block 2 internally includes a first fluid pressure circuit and a second fluid pressure circuit (both not shown in FIG. 1). Here, the first fluid pressure circuit has one end connected to one of pressure chambers of a tandem master cylinder, and has other two branched ends connected to the corresponding wheel cylinders of two front wheels of the vehicle (longitudinally sprit) or to a right front wheel and a left rear wheel of the vehicle (diagonally sprit). Also, the second fluid pressure circuit has one end connected to another one of the pressure chambers of the master cylinder, and has other two branched ends connected to wheel cylinders of other remained two wheels. Also, the fluid pressure controlling block 2 includes well-known components for controlling fluid pressure of each wheel cylinder, such as solenoid valves 18, which increase and decrease fluid pressure of wheel cylinders when required depending on a command from an electronic control unit. Components assembled into the fluid pressure controlling block 2 will be described in detail later.

The fluid pressure controlling block 2 defines a fluid chamber 4 therein, which is connected with the fluid pressure circuit, and an electronic component 5 (e.g., a pressure sensor for sensing a brake fluid pressure shown in FIG. 1) is mounted on the fluid pressure controlling block 2. Here, the electronic component 5 has a sensing portion at an end that faces the fluid chamber 4, and a gap between an periphery of the end portion of the electronic component 5 and the fluid chamber 4 is fluid-tightly sealed.

The controller 3 includes a resin case 6, a resin cover 7, and a circuit board 9. Here, the case 6 covers components on the fluid pressure controlling block 2, and the cover 7 is attached to the case 6. Alternatively, the cover 7 may be made of metal, instead of the resin. Also, the cover 7 receives an electronic control unit (ECU) 8, which is mounted on the circuit board 9. The case 6 includes a metal sleeve 10 embedded therein for reinforcing a mounting bore. The metal sleeve 10 receives a threaded member 11, and the threaded member 11, which is inserted into the metal sleeve 10, fixes the case 6 to the fluid pressure controlling block 2. The cover 7 is removably attached to the case 6 through a fastening element (not shown), such as a threaded member.

The circuit board 9 is provided with a control circuit (not shown), and the control circuit has certain parts, to which terminals T of components mounted on the fluid pressure controlling block 2, such as the electronic component 5 and the solenoid valves 18, are connected. The circuit board 9 has a grounded portion (ECU GND) EG, which is electrically connected with a connector (not shown), which is connected with a battery of the vehicle through a harness.

Also, the case 6 has an electric conductor 12 (e.g., a bus bar in FIG. 1). The electric conductor 12 has one end connected with the grounded portion EG of the circuit board 9 in the cover 7, and has another end electrically connected with the fluid pressure controlling block 2 through the metal sleeve 10 and the threaded member 11. Due to this structure, the fluid pressure controlling block 2 and the grounded portion EG of the circuit board 9 are electrically connected through the electric conductor 12 such that the fluid pressure controlling block 2 and the grounded portion EG has the same electrical potentials. Thus, a noise is not likely to be induced to the electronic component 5 and therefore, even an electronic component, which has relatively small noise resistance (e.g., a normal electronic component with a normal noise resistance), can be employed in a severe noise environment. Conduction to the grounded portion EG within the cover 7 can advantageously shorten the electric conductor 12. This can also brings advantages in productivity, a parts control, and cost in manufacture.

A capacitor 13 may be provided between the electric conductor 12 and the grounded portion EG of the circuit board 9. In a case, where the capacitor 13 is provided, the capacitor 13 selectively permits a noise element to flow.

It is noted that the electric conductor 12 shown in FIG. 1 has a bending portion 12a at the another end thereof, and the bending portion 12a and the case 6 are fastened together to the fluid pressure controlling block 2 though the threaded member 11, which is screwed into the fluid pressure controlling block 2. Thus, work units (e.g., manhour) for assembling the controller 3 can be advantageously reduced. Further, the metal sleeve 10 has one end in contact with the electric conductor 12 and another end in contact with the fluid pressure controlling block 2. In this structure, because the electric conductor 12 can be electrically connected with the fluid pressure controlling block 2 through the metal sleeve 10 and the threaded member 11, a preferable electrical connection can be achieved without extending the electric conductor 12 to contact the fluid pressure controlling block 2.

In addition to the above, in a case, where a bus bar of a rigid body as shown in the drawing is employed as the electric conductor 12, the electric conductor 12 is easily mounted. In a case where a flexible harness is used as an electric conductor fixed through a threaded member, a terminal needs to be attached to the flexible harness. However, the bus bar eliminates the labor hour for this assembly.

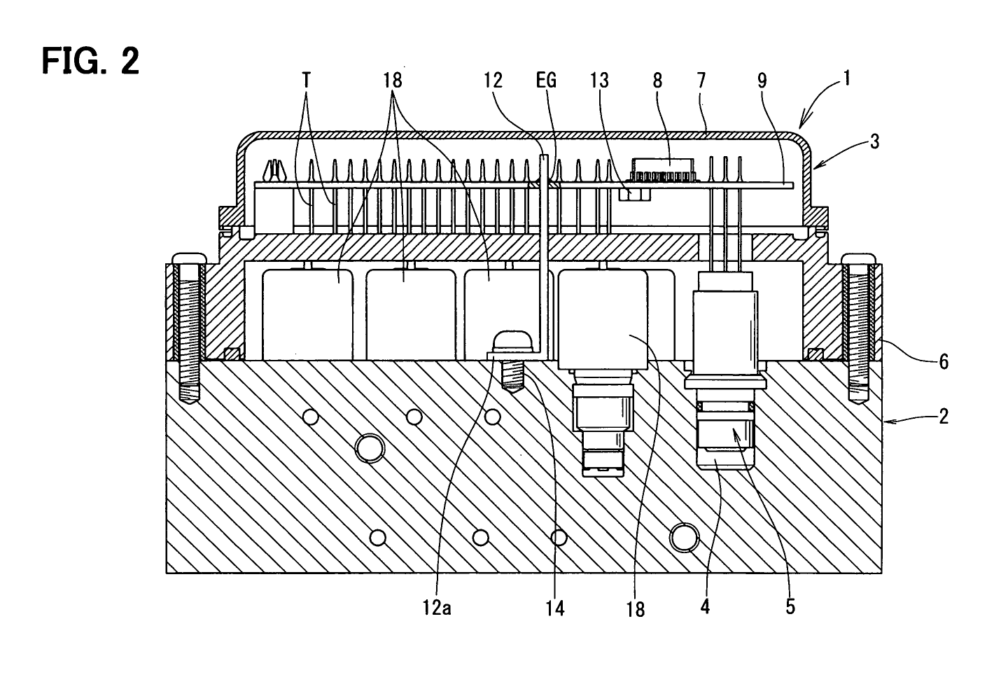

The electric conductor 12 and the case 6 are not essentially required to be fixed together in the present invention. In a case of use of an external fastening type case, in which the threaded member 11 fastens the case 6 to the fluid pressure controlling block 2 by externally fastening as shown in FIG. 2, the electric conductor 12 may be solely fastened to the fluid pressure controlling block 2 by a threaded member 14.

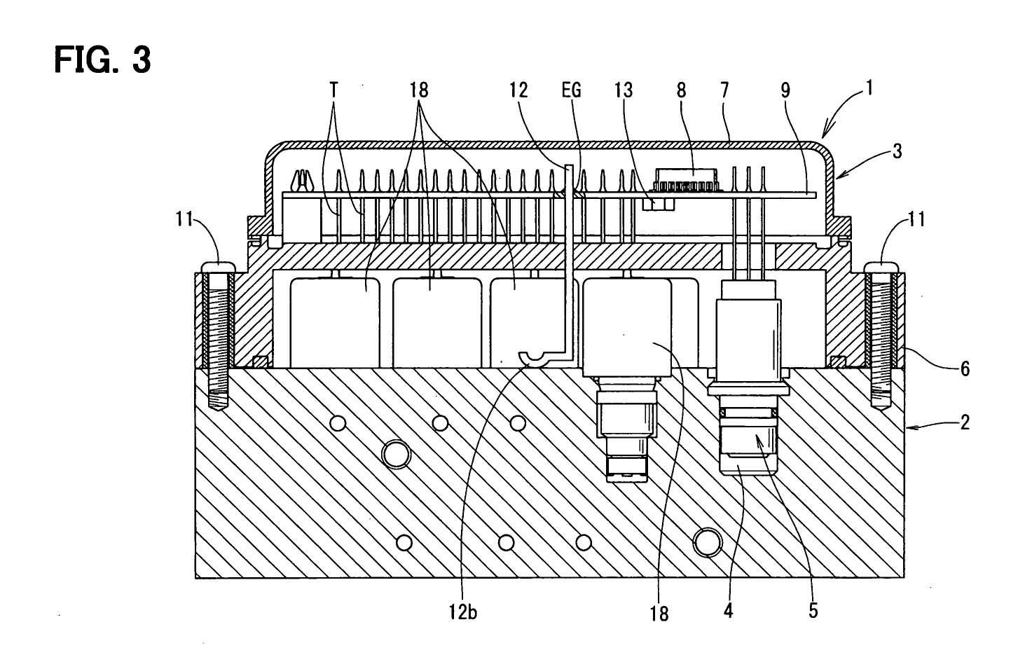

The electric conductor 12 may alternatively press contact the fluid pressure controlling block 2 as shown in FIG. 3 such that the electric conductor 12 can be electrically connected with the fluid pressure controlling block 2. In a brake fluid pressure controlling unit 1 shown in FIG. 3, the electric conductor 12 is configured by a bus bar, and extends through the case 6 to be assembled thereto. Here, the electric conductor 12 has a contacting portion 12b at the another end thereof such that the contacting portion 12b is pressed against the fluid pressure controlling block 2. Here, the contacting portion 12b is made by bending and is resiliently deformable. In this structure, a work unit for screwing the electric conductor 12 can be eliminated, and thus operability can be improved.

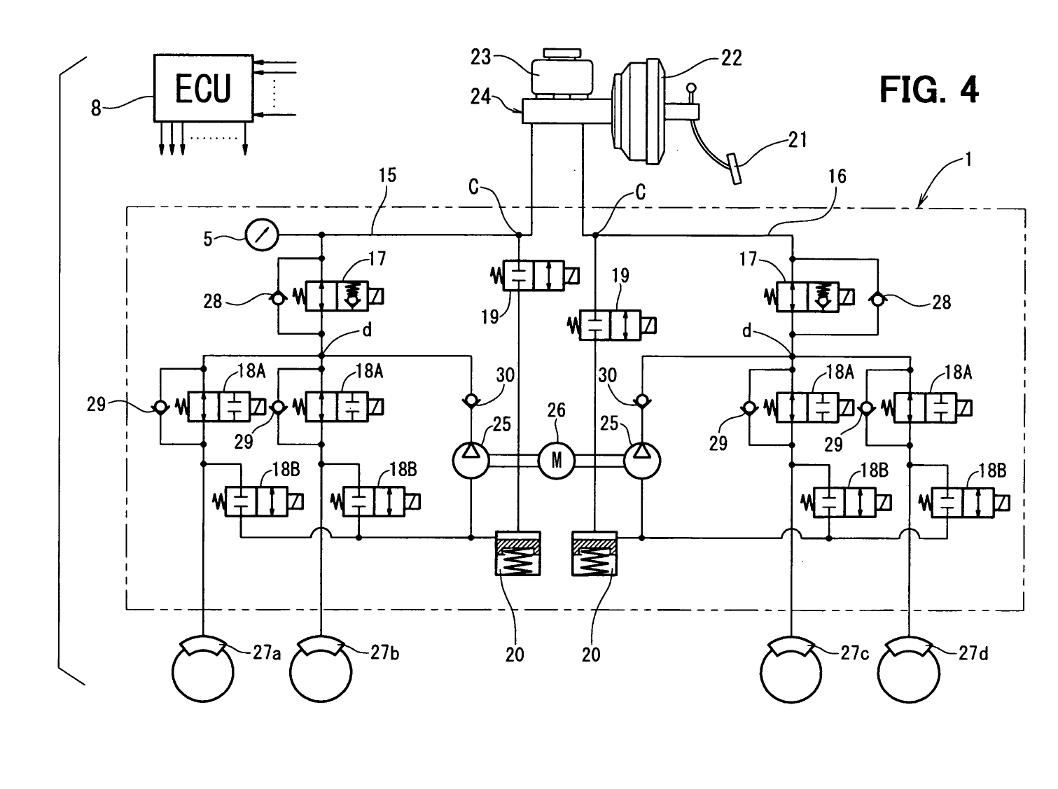

Next, an example of a circuit configuration of a brake fluid pressure controlling system for a vehicle will be shown in FIG. 4. The brake system shown in FIG. 4 has an electronic stability control (ESC) function, and includes a brake pedal 21, a tandem master cylinder 24, the above brake fluid pressure controlling unit 1, and wheel cylinders 27a to 27d for respective wheels. Here, the tandem master cylinder 24 has a reservoir 23 and a fluid pressure booster 22, which augments a brake operation force applied by a driver.

In the brake fluid pressure controlling unit 1, the fluid pressure controlling block 2 (see FIG. 1) internally has fluid pressure circuits 15, 16, which are connected to respective pressure chambers of the master cylinder 24. A linear control valve 17 is assembled to each of the fluid pressure circuits 15, 16. Boost solenoid valves 18A are assembled to branch passages of each fluid pressure circuit downstream of a branch point d (e.g., in the present embodiment of the present invention, “downstream” means a side closer to the wheel cylinders). Furthermore, a vacuum solenoid valve 18B is assembled to a circuit connected to each branch passage downstream of the boost solenoid valve 18A.

Here, the fluid pressure controlling block 2 includes reservoirs 20, pumps 25, and a motor 26. Here, working fluid (brake fluid) discharged from the vacuum solenoid valves 18B is temporally reserved in each reservoir 20. Also, each pump 25 pumps the working fluid accumulated in each reservoir 20 to recycle the working fluid in the corresponding fluid pressure circuit. It is noted that when the master cylinder is not in operation and the reservoir 20 has no available fluid accumulated therein, the working fluid in the reservoir 23 is pumped via a solenoid valve 19 to the corresponding fluid pressure circuit. The motor 26 drives these pumps 25. In FIG. 4, each of check valves 28 is arranged in parallel with the corresponding linear control valve 17, and each of check valves 29 is arranged in parallel with corresponding boost solenoid valve 18A. Also, each of check valves 30 can be alternatively assembled inside the corresponding pump 25.

Also, in the above embodiment, the fluid pressure controlling block includes single electronic component 5 (pressure sensor) for sensing the fluid pressure in the fluid pressure circuit 15 upstream of the linear control valve 17. However, two or three of pressure sensors may be alternatively provided by locating additional ones at other parts. Thus, the present invention can be more effectively applied to the above brake system, where a fluid pressure controlling block of a brake fluid pressure controlling unit includes two or three pressure sensors, which are one example of the electronic component.

In the above embodiment, the pressure sensor is described as the electronic component mounted on the fluid pressure controlling block. However, other information for the fluid pressure control (e.g., acceleration of the vehicle) other than the fluid pressure may be alternatively sensed by a sensor. Then, this information may be received by the electronic control unit 8. Even in this case, when the structure described in the present invention is applied, abnormal control can also be effectively limited. Otherwise, because the sensor, which is mounted on the fluid pressure controlling block to sense the other information other than the fluid pressure, may abnormally operate due to a noise, the electronic control unit 8 may receive erroneous information, thereby degrading reliability of the control.

Additional advantages and modifications will readily occur to those skilled in the art. The invention in its broader terms is therefore not limited to the specific details, representative apparatus, and illustrative examples shown and described.

What is claimed is:

1. A brake fluid pressure controlling unit for a vehicle, comprising:
a metal fluid pressure controlling block that is electrically connected with a body of the vehicle;
a cover that is fixed to the fluid pressure controlling block;
a circuit board that is received inside the cover, wherein an electronic control unit is mounted on the circuit board;
an electronic component that is assembled to the fluid pressure controlling block; and
an electric conductor that is connected with a grounded portion of the circuit board in the cover, the grounded portion being grounded, wherein the electric conductor electrically connects the fluid pressure controlling block with the grounded portion of the circuit board.

2. The controlling unit according to claim 1, further comprising:
a capacitor that is provided between the electric conductor and the grounded portion of the circuit board, the grounded portion being connected with the electric conductor.

3. The controlling unit according to claim 1, further comprising:
a threaded member, through which the electric conductor is fixed to the fluid pressure controlling block.

4. The controlling unit according to claim 1, further comprising:
a case that is provided between the fluid pressure controlling block and the circuit board received inside the cover; and
a threaded member that fastens the case and the electric conductor together to the fluid pressure controlling block, the threaded member being screwed into the fluid pressure controlling block.

5. The controlling unit according to claim 4, further comprising:
a metal sleeve that is embedded in the case, wherein:
the threaded member is inserted into the metal sleeve;
the metal sleeve has one end in contact with the electric conductor and another end in contact with the fluid pressure controlling block; and
the electric conductor is electrically connected with the fluid pressure controlling block through the metal sleeve and the threaded member.

6. The controlling unit according to claim 5, wherein the electric conductor is configured by a bus bar.

7. The controlling unit according to claim 1, wherein:
the electric conductor is configured by a bus bar; and
the electric conductor has one end in pressure contact with the fluid pressure controlling block such that the electric conductor is electrically connected with the fluid pressure controlling block.

8. The controlling unit according to claim 6, wherein:
the electronic component is a sensor, which collects information for fluid pressure control, and which outputs the information to the electronic control unit.

9. The controlling unit according to claim 8, wherein:
the sensor is a pressure sensor for sensing a fluid pressure inside a brake system.

10. The controlling unit according to claim 2, further comprising:
a threaded member, through which the electric conductor is fixed to the fluid pressure controlling block.

11. The controlling unit according to claim 10, wherein the electric conductor is configured by a bus bar.

12. The controlling unit according to claim 11, wherein:
the electronic component is a sensor, which collects information for fluid pressure control, and which outputs the information to the electronic control unit.

13. The controlling unit according to claim 12, wherein:
the sensor is a pressure sensor for sensing a fluid pressure inside a brake system.

14. The controlling unit according to claim 2, further comprising:
a case that is provided between the fluid pressure controlling block and the circuit board received inside the cover; and
a threaded member that fastens the case and the electric conductor together to the fluid pressure controlling block, the threaded member being screwed into the fluid pressure controlling block.

15. The controlling unit according to claim 14, further comprising:
a metal sleeve that is embedded in the case, wherein:
the threaded member is inserted into the metal sleeve;
the metal sleeve has one end in contact with the electric conductor and another end in contact with the fluid pressure controlling block; and
the electric conductor is electrically connected with the fluid pressure controlling block through the metal sleeve and the threaded member.

16. The controlling unit according to claim 15, wherein the electric conductor is configured by a bus bar.

17. The controlling unit according to claim 16, wherein:
the electronic component is a sensor, which collects information for fluid pressure control, and which outputs the information to the electronic control unit.

18. The controlling unit according to claim 17, wherein:
the sensor is a pressure sensor for sensing a fluid pressure inside a brake system.

19. The controlling unit according to claim 2, wherein the electric conductor is configured by a bus bar.

20. The controlling unit according to claim 2, wherein:
the electric conductor is configured by a bus bar; and
the electric conductor has one end in pressure contact with the fluid pressure controlling block such that the electric conductor is electrically connected with the fluid pressure controlling block.
